(19) United States
(12) Patent Application Publication
(10) Pub. No.: US 2023/0360399 A1
(43) Pub. Date: Nov. 9, 2023

(54) SEGMENTATION OF A SEQUENCE OF VIDEO IMAGES WITH A TRANSFORMER NETWORK

(71) Applicant: Robert Bosch GmbH, Stuttgart (DE)

(72) Inventors: Nadine Behrmann, München (DE); Mehdi Noroozi, Stuttgart (DE); S. Alireza Golestaneh, Pittsburgh, PA (US)

(21) Appl. No.: 18/308,452

(22) Filed: Apr. 27, 2023

(30) Foreign Application Priority Data
May 6, 2022 (DE) 10 2022 204 493.2

(51) Int. Cl. G06V 20/40; G06V 10/774; G06V 10/82; G06V 10/74; G06V 10/776

(52) U.S. Cl. CPC G06V 20/49; G06V 20/46; G06V 20/41; G06V 10/774; G06V 10/82; G06V 10/761; G06V 10/776

(57) ABSTRACT

A method for transforming a frame sequence of video frames into a scene sequence of scenes. In the method: features are extracted from each video frame, and are transformed into a feature representation in a first working space; a feature interaction of each feature representation with the other feature representations is ascertained, characterizing a frame prediction; the class belonging to each already-ascertained scene is transformed into a scene representation in a second working space; a scene interaction of a scene representation with each of all the other scene representations is ascertained; a scene-feature interaction of each scene interaction with each feature interaction is ascertained; and from the scene-feature interactions, at least the class of the next scene in the scene sequence that is most plausible in view of the frame sequence and the already-ascertained scenes is ascertained.

### CROSS REFERENCE

The present application claims the benefit under 35 U.S.C. § 119 of German Patent Application No. DE 10 2022 204 493.2 filed on May 6, 2022, which is expressly incorporated herein by reference in its entirety.

### FIELD

The present invention relates to the division of a sequence of video images into semantically different scenes.

### BACKGROUND INFORMATION

For the automated evaluation of video material, it is often necessary to divide a sequence of video images into scenes. For example, a recording of a surveillance camera can herewith be divided into individual recorded scenes in order to have quick access to each of these scenes. For example, the video frames can be classified individually according to the type of scene they belong to. Training appropriate classifiers requires many sequences of video frames, each labeled with the type of the current scene, as training examples.

### SUMMARY

The present invention provides a method for transforming a frame sequence of video frames into a scene sequence of scenes. These scenes have different semantic meanings, which is encoded in the fact that the scenes belong to different classes of a classification. For example, different scenes can correspond to different classes, so that there is only one scene per class. However, if multiple scenes have the same semantic meanings (such as a new customer entering the field of view of a surveillance camera in a place of business), these scenes may be assigned to the same class. Each scene extends over a region on the time axis, which can be coded as desired, for example in the form of start and duration, or in the form of start and end.

According to an example embodiment of the present invention, in the method, features are extracted from each video frame in the frame sequence. This significantly reduces the dimensionality of the video frames. For example, a feature vector with only a few thousand elements can represent a full HD video frame that includes several million numerical values. Any suitable standard feature extractor can be used for this purpose.

The features associated with each video frame are transferred into a feature representation in a first working space. In this feature representation, the position of the respective video frame in the frame sequence is optionally encoded. From each feature representation, it can therefore be learned at which position it stands in the series of feature representations.

Likewise, when calculating a plurality of feature representations, it can automatically be taken into account how close these feature representations are to each other in the series.

A transformer network is now used for further processing of the feature representations. A transformer network is a neural network that is specifically designed to receive data in the form of sequences as input and to process it to form new sequences that form the output of the transformer network. For this purpose, a transformer network includes an encoder that transforms the input into an intermediate product, and a decoder that processes this intermediate product, and optionally other data, to form the output. Transformer networks are here distinguished in that both the encoder and the decoder each contain at least one so-called attention block. Corresponding to its training, this attention block links the inputted data together, and for this purpose has access to all data to be processed. Thus, the “field of view” of the attention block is not limited by, for example, a given size of filter kernels or by a limited receptive field. Therefore, transformer networks are suitable, for example, for processing entire sentences in the machine translation of texts.

For the object in the present case, the trainable encoder of the transformer network is used to ascertain a feature interaction of each feature representation with respective other feature representations, i.e. some or all of these feature representations. For this purpose, the at least one attention block in the encoder is used, which puts all feature representations into relation with each other. The feature interactions ascertained in this way characterize a frame prediction, which already contains an item of information as to which frame could belong to which class. That is, the frame prediction can be determined given knowledge of the feature interactions, for example with a linear layer of the transformer network.

The class belonging to each already-ascertained scene, as well as, optionally, the region on the time axis belonging to this scene, are now transferred into a scene representation in a second working space. In this scene representation, the position of the respective scene in the scene sequence is encoded.

Analogous to the feature representations, from the scene representations it can thus be inferred where in the series of scene representations it stands. In the calculation of multiple scene representations, a possible adjacency in the series of scene representations can also be taken into account. At the beginning of the method, when no scenes have yet been identified, a “Start of Sequence token” (SoS token) is processed instead of a scene.

The trainable decoder of the transformer network is used to ascertain a scene interaction of one scene representation with each of all the other scene representations. For this purpose a first attention block in the decoder is used. In addition, the decoder is also used to ascertain a scene-feature interaction of each scene interaction with each feature interaction. For this purpose, a second attention block in the decoder is used, which puts all scene interactions into relation with all feature interactions.

From the scene-feature interactions, the decoder ascertains at least the class of the most plausible next scene in the scene sequence given the frame sequence and the already-ascertained scenes. Thus, with this iterative, autoregressive approach, at least one sequence of the types of scenes emerges. For example, the scene sequence of a video from a surveillance camera can repeatedly change between “area is empty,” “customer enters shop” and “customer leaves shop.” This evaluation of the classes can already be used to subsequently ascertain the regions on the time axis occupied by the respective scenes, using standard methods such as Viterbi and FIFA. However, in the following possibilities are also presented as to how these regions can be ascertained more quickly. For example, Viterbi is used to calculate the global optimum of an energy function. The Viterbi runtime is quadratic, and is thus slow for long videos. FIFA represents an approximation and can end in local optima, but in return is much faster, but still takes a certain amount of time in the inference. The networks used in the method proposed here are trained models and therefore can perform the inference with a single forward pass. This is faster than, for example, Viterbi or FIFA.

The use of a transformer network offers the advantage that class assignments can be searched directly on the level of the scenes. It is not necessary to first ascertain class assignments at the level of the individual video frames and then aggregate this information to form the sought sequence of scenes. For one, this subsequent aggregation is a source of error. Also, the search for class assignments at the level of the video frames is in extremely small parts, so that the frame sequence may be “oversegmented.” This can happen in particular if only a few training examples are available for the training of corresponding classifiers. However, training examples, particularly at the level of the individual video frames, can often only be obtained through expensive manual labeling and are therefore scarce. For example, “oversegmenting” can result in actions being detected that do not actually take place. In particular, if such actions are counted for example by a monitoring system, an excessive number of actions may be ascertained.

The transformer network, on the other hand, does not attempt to “oversegment” the frame sequence, because classes are not assigned at the level of the video frames, but at the level of the scenes.

The above-described structured preparation of the information in the transformer network also opens up further possibilities for ascertaining the regions occupied on the time axis in each case by the ascertained scenes more quickly than before. Some of these possibilities are indicated below.

In particular, according to an example embodiment of the present invention, the ascertaining of the feature interactions can involve ascertaining similarity measures implemented in any suitable manner between the respective feature representation and each of all the other feature representations. Contributions from each of the other feature representations can then be aggregated in weighted fashion with these similarity measures. In particular, a similarity measure can be implemented as a distance measure, for example. In this way, feature representations that are close or similar to each other enter more strongly into the ascertained feature interaction than feature representations that objectively do not have much to do with each other.

Similarly, according to an example embodiment of the present invention, the ascertaining of the scene interactions can include, in particular, ascertaining similarity measures between the respective scene representation and each of all the other scene representations. Contributions from each of the other scene representations can then be aggregated in weighted fashion with these similarity measures.

The scene-feature interactions can also be ascertained in an analogous manner. Thus, similarity measures between the respective scene interaction and the feature interactions can be ascertained, and contributions of the feature interactions can then be aggregated using these similarity measures.

Particularly advantageously, according to an example embodiment of the present invention, feature representations, feature interactions, scene representations, scene interactions, and scene-feature interactions can each be divided into a query portion, a key portion, and a value portion. Thus, for example, transformations with which features and scenes are each transformed into representations can be designed such that representations with just this subdivision are obtained. This subdivision is then preserved, given suitable processing of the representations. For the purpose of calculating similarity measures, query portions are comparable with key portions, analogous to a query being made to a database and a search being made therewith for data sets (value) that are stored in the database in association with a matching key.

In a particularly advantageous embodiment of the present invention, however, the region on the time axis over which the next scene extends is ascertained using a trained auxiliary decoder network that receives both the classes provided by the decoder of the transformer network and the feature interactions as inputs. In this way, the accuracy with which the region is ascertained can be increased once again. For the decoder itself, it is comparatively difficult to ascertain the region occupied on the time axis, because the frame sequence inputted to the transformer network is orders of magnitude longer than the scene sequence outputted by the transformer network. While the correct class can be predicted based on only a single frame, frames must be counted to predict the region occupied on the time axis. In that the auxiliary decoder network now also accesses the very well localized information in the feature interactions and fuses this information with the output of the decoder, the localization of the scene on the time axis can be advantageously improved.

The present invention also provides a method for training a transformer network for use in the method described above.

According to an example embodiment of the present invention, in this method, training frame sequences of video frames are provided that are labeled with target classes of scenes to which the video frames each belong. Each of these training frame sequences is transformed into a scene sequence of scenes using the method described earlier.

A given cost function (also called a loss function) is used at least to evaluate to what extent at least the ascertained scene sequence, and optionally the frame prediction, is in accord with the target classes of scenes with which the video frames are labeled in the training frame sequences.

Parameters that characterize the behavior of the transformer network are optimized with the goal that in further processing of training frame sequences, the evaluation by the cost function is advantageously improved.

As explained above, the transformer network trained in this way no longer tends to oversegment the video sequence.

The cost function can be made up of a plurality of modules. An example of such a module is

$${ℒ}_{segment} = - \frac{1}{N} {\sum }_{i = 1}^{N} log ( {a}_{i , \hat{c}} ) .$$

Here, N is the number of scenes in the scene sequence. a_{i,c} is the probability, predicted with the transformer network, that the scene i belongs to the class c. ĉ is the target class that should be assigned to the scene i according to ground truth.

In a particularly advantageous embodiment of the present invention, the cost function additionally measures the extent to which the decoder assigns each video frame to the correct scene. If the encoder needs to catch up in this respect, corresponding feedback can be provided faster than by the “detour” via the decoder. In this way, the cost function can also contain a frame-based portion, which can be written for example as

$${ℒ}_{frame} = - \frac{1}{T} {\sum }_{t = 1}^{T} log ( {y}_{t , \hat{c}} ) .$$

Here y_{t,c} is the probability predicted by the encoder that the frame t belongs to the class c and ĉ is the target class to which this frame is to be assigned according to ground truth. This ground truth can be derived from the ground truth relating to the scene i to which the frame t belongs.

In another particularly advantageous embodiment of the present invention, in addition the video frames in the training frame sequences, as well as the ascertained scenes, are sorted by class. The cost function then additionally measures the agreement of the respective class prediction averaged over all members of the classes with the respective target class. If [symbol] is the set of all possible classes,

L={c∈ [symbol] |cϵ{â₁, . . . , âₙ}}

is the set of all classes c that occur in the frame sequence (or in the ascertained scene sequence) according to ground truth,

T_{c}={t∈{1, . . . , T}|ŷₜ=c}

are the indices of the frames that belong to the class c according to ground truth and

N_{c}={i∈{1, . . . , N}|âᵢ=c}

are the indices of the scenes that belong to class c according to ground truth, then with respect to the groups of video frames a cross-entropy contribution

$${ℒ}_{g - frame} = - \frac{1}{‖ L ‖} {\sum }_{c ∈ L} log ( \frac{1}{‖ {T}_{c} ‖} {\sum }_{t ∈ {T}_{c}} {y}_{t , c} )$$

and with respect to the groups of scenes a cross-entropy contribution

$${ℒ}_{g - segment} = - \frac{1}{‖ L ‖} {\sum }_{c ∈ L} log ( \frac{1}{‖ {N}_{c} ‖} {\sum }_{i ∈ {N}_{c}} {a}_{i , c} )$$

can be set up. These contributions regularize the outputs of the encoder and the decoder.

In another particularly advantageous embodiment of the present invention, parameters that characterize the behavior of the auxiliary decoder network are additionally optimized. The cost function then additionally measures the extent to which the auxiliary decoder network assigns each video frame to the correct scene. In this way, the features E∈ [symbol] ^{T×d}′ supplied by the encoder can be adjusted against the very distinctive features D∈ [symbol] ^{N×d}′ supplied by the decoder. Via cross-attention between E and D, adjusted features A∈ [symbol] ^{T×d}′ are obtained. Another cross-attention between A and D then yields an assignment matrix

$$M = softmax ( \frac{{AD}^{T}}{τ \sqrt{{d}^{′}}} ) ,$$

which assigns each video frame to a scene. For a small τ there results a hard “one-hot” assignment of each video frame to exactly one scene. M is trained to predict the scene index for each video frame. This prediction can still be ambiguous at first, if an action occurs at a plurality of places in the frame sequence (or scene sequence). However, this ambiguity can be resolved by encoding the position of the video frame in the frame sequence, or the position of the scene in the scene sequence, before the cross-attention. In this way, for the behavior of the auxiliary decoder as a whole, a contribution

$${ℒ}_{CA} ( M ) = - \frac{1}{T} {\sum }_{t = 1}^{T} log ( {M}_{t , \hat{n}} )$$

can be set up. Here n is the index of the scene to which the video frame t belongs according to ground truth. In contrast to the decoder of the transformer network, the auxiliary decoder network does not work autoregressively: It can work with the already complete sequence of frame features supplied by the encoder and with the already complete sequence of scene features supplied by the decoder. The time durations uᵢ of the scenes i can be summed up from the assignments M:

$${u}_{i} = {\sum }_{t = 1}^{T} {M}_{t , i} .$$

Independently of the training of the auxiliary decoder, a module analogous to [symbol] _{CA}(M) can also be used in the cost function for training the transformer network. For this purpose, for example, the assignments M can be modified to

$$\overline{M} = softmax ( \frac{{S}^{′} {E}^{′ T}}{τ \sqrt{{d}^{′}}} ) .$$

Thus, as the total cost function for training the transformer network for example

[symbol]

=λ₁ [symbol] _{frame}+λ₂ [symbol] _{segment}+λ₃ [symbol] _{g-frame}+λ₄ [symbol] _{g-segment}+λ₅ [symbol] _{CA}(M̅)

can be used. Here the λ₁₋₅ are the weighting coefficients. Parallel to this, and/or after training the transformer network, the auxiliary decoder can be trained with the cost function [symbol] _{CA}(M) described above.
Particularly advantageously, according to an example embodiment of the present invention, during the training of the auxiliary decoder network the parameters that characterize the behavior of the transformer network are held constant. In this way, the tendency of the overall network to overfitting can be further reduced.

In another advantageous embodiment of the present invention, the labeled video frames are clustered with respect to their target classes. Missing target classes for unlabeled video frames are then ascertained according to the clusters to which these unlabeled video frames belong. In this way, even a frame sequence can be analyzed in which by far not all video frames are labeled with target classes. It is sufficient to label one frame per scene of the sequence with a target class.

The methods may be fully or partially computer-implemented and thus embodied in software. Thus, the present invention also relates to a computer program having machine-readable instructions that, when they are executed on one or more computers and/or compute instances, cause the computer(s) and/or compute instances to carry out one of the methods described here. In this sense, control devices for vehicles and embedded systems for technical devices that are also capable of executing machine-readable instructions are also to be regarded as computers. In particular, compute instances can be, for example, virtual machines, containers, or other execution environments for executing program code in a cloud.

Likewise, the present invention also relates to a machine-readable data carrier and/or to a download product with the computer program. A download product is a digital product that is transferable via a data network, i.e. downloadable by a user of the data network, that can be offered for sale for example in an online shop for immediate download.

Furthermore, one or more computer and/or compute instances may be equipped with the computer program, with the machine-readable data carrier, or with the download product.

Further measures that improve the present invention are described in more detail below together with the description of preferred exemplary embodiments of the present invention on the basis of figures.

### BRIEF DESCRIPTION OF THE DRAWINGS

FIG. 1 shows an exemplary embodiment of method 100 for transforming a frame sequence 1 of video frames 10-19 into a scene sequence 2 of scenes 21-25, according to the present invention.

FIG. 2 shows an exemplary embodiment of method 200 for training a transformer network 5, according to the present invention.

FIG. 3 shows an exemplary system made up of transformer network 5 and auxiliary decoder network 6, according to the present invention.

### DETAILED DESCRIPTION OF EXAMPLE EMBODIMENTS

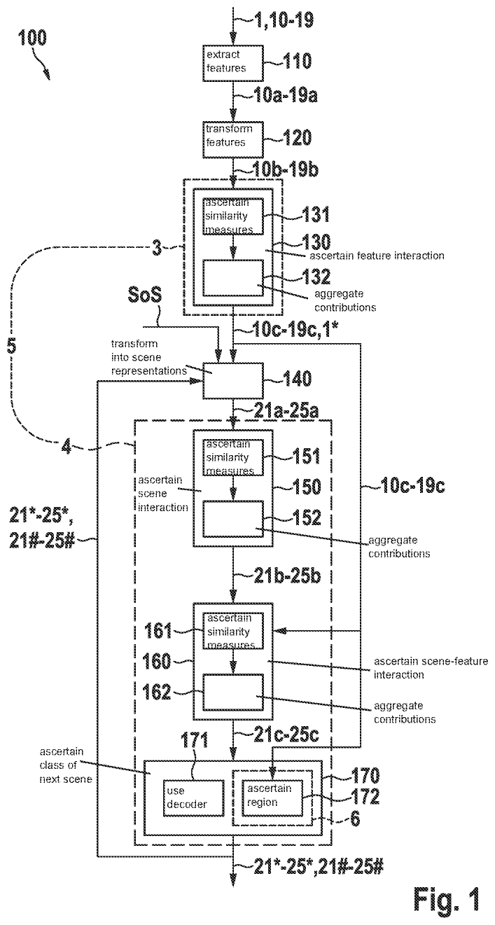

FIG. 1 is a schematic flow diagram of an exemplary embodiment of method 100 for transforming a frame sequence 1 of video frames 10-19 into a scene sequence 2 of scenes 21-25.

In step 110, features 10a-19a are extracted from each video frame 10-19 of frame sequence 1.

In step 120, the features 10a-19a belonging to each video frame 10-19 are transformed into a feature representation 10b-19b in a first working space. Here, the position of the respective video frame 10-19 in frame sequence 1 is optionally encoded in feature representation 10b-19b.

In step 130, a trainable encoder 3 of a transformer network 5 is used to ascertain a feature interaction 10c-19c of each feature representation 10b-19b with each of all the other feature representations 10b-19c. That is, one given feature representation 10b-19b is respectively put into relation to all other feature representations 10b-19b, and the result is then the respective feature interaction 10c-19c. Feature interactions 10c-19c together form frame prediction 1*.

According to block 131, similarity measures may be ascertained between the respective feature representation 10b-19b and respective other feature representations 10b-19b, i.e. some or all of these other feature representations 10b-19b. According to block 132, contributions from each of the other feature representations 10b-19b can then be aggregated in weighted fashion with these similarity measures.

In step 140, the class 21*-25* associated with each already-ascertained scene 21-25, as well as the region 21#-25# on the time axis in the example shown in FIG. 1, are transformed into a scene representation 21a-25a in a second working space. The position of the respective scene 21-25 in the scene sequence 2 is encoded in this scene representation 21a-25a. At the beginning of method 100, when no scenes 21-25 have yet been ascertained, a Start of Sequence (SoS) token is used in place of classes 21*-25* and regions 21#-25#.

In step 150, a trainable decoder 4 of the transformer network 5 is used to ascertain a scene interaction 21b-25b of a scene representation 21a-25a with each of all the other scene representations 21a-25a. That is, a given scene representation 21a-25a is put into relation to all other scene representations 21a-25a at a time, and the result is then the respective scene interaction 21b-25b.

According to block 151, similarity measures may be ascertained between the respective scene representation 21a-25a and each of all the other scene representations 21a-25a. According to block 152, contributions from each of the other scene representations 21a-25a can then be aggregated in weighted fashion with these similarity measures.

In step 160, a scene-feature interaction 21c-25c of each scene interaction 21b-25b with each feature interaction 10c-19c is ascertained with decoder 4. That is, a given scene interaction 21b-25b is put into relation to each of all the feature interactions 10c-19c, and the result is then the respective scene-feature interaction 21c-25c.

According to block 161, similarity measures between the respective scene interaction 21b-25b and the feature interactions 11c-15c can be ascertained. According to block 162, contributions of feature interactions 11c-15c can then be aggregated in weighted fashion with these similarity measures.

In step 170, decoder 4 ascertains at least the class 21*-25* of the next scene 21-25 in the scene sequence 2 that is most plausible in view of frame sequence 1 and the already-ascertained scenes 21-25. This information can then be fed back to step 140 in the autoregressive process to ascertain the respective next scene 21-25.

According to block 171, the class 21*-25* of the next scene 21-25, as well as, optionally, the region 21#-25# on the time axis over which the next scene 21-25 extends, can be ascertained using decoder 4 of transformer network 5.

According to block 172, the region 21#-25# on the time axis over which the next scene 21-25 extends can be ascertained using a trained auxiliary decoder network 6. This auxiliary decoder network 6 receives as inputs both the scene-feature interactions 21c-25c generated by decoder 4 of transformer network 5 and the feature interactions 10c-19c. This auxiliary decoder network 6 is not part of the autoregression.

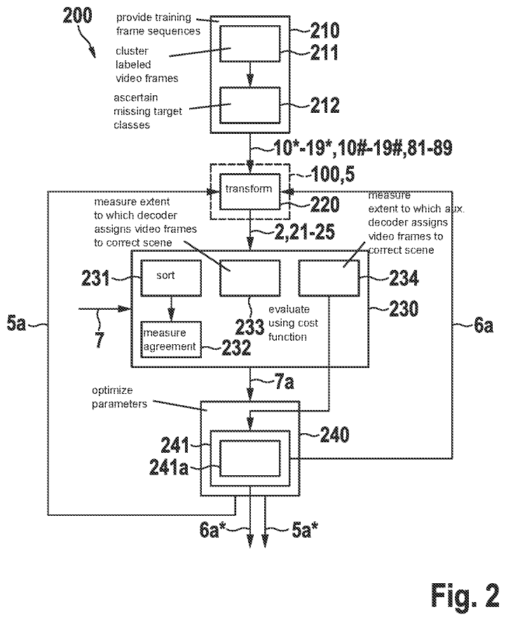

FIG. 2 is a schematic flow diagram of an exemplary embodiment of method 200 for training a transformer network 5 for use in the above-described method 100.

In step 210, training frame sequences 81-89 of video frames 10*-19* are provided. These training frame sequences 81-89 are labeled with target classes 10#-19# of scenes 21-25 to which video frames 10*-19* belong respectively. That is, video frames 10*-19* are each labeled with target classes 10#-19#, and these labels 10#-19# are assigned to the training frame sequence 81-89 as a whole.

According to block 211, the labeled video frames 10*-19* can be clustered with respect to their target classes 10#-19#. According to block 212, missing target classes 10#-19# for unlabeled video frames 10*-19* can then be ascertained according to the clusters to which these unlabeled video frames 10*-19* belong.

In step 220, each training frame sequence 81-89 is transformed into a scene sequence 2 of scenes 21-25 using the above-described method 100. As explained above, a frame prediction 1* is also formed in this process.

In step 230, a predetermined cost function 7 is used to evaluate at least the extent to which the ascertained scene sequence 2, and optionally also the frame prediction 1*, are in accord with the target classes 10#-19# of scenes with which the video frames 10*-19* are labeled in the training frame sequences 81-89.

According to block 231, in addition the video frames 10*-19* in the training frame sequences 81-89 and the ascertained scenes 21-25 can be sorted by class. According to block 232, cost function 7 can then measure the agreement of the respective class prediction averaged over all members of the classes with the respective target class 10#-19#.

According to block 233, cost function 7 can additionally measure the extent to which decoder 4 assigns each video frame 10*-19* to the correct scene 21-25.

According to block 234, cost function 7 may additionally measure the extent to which auxiliary decoder network 6 assigns each video frame 10*-19* to the correct scene 21-25.

In step 240, parameters 5a that characterize the behavior of transformer network 5 are optimized with the goal that further processing of training frame sequences 81-89 will be expected to improve the evaluation 7a by cost function 7. The final trained state of parameters 5a is designated by the reference sign 5a*.

If cost function 7 according to block 234 measures the extent to which auxiliary decoder network 6 assigns each video frame 10*-19* to the correct scene 21-25, parameters 6a that characterize the behavior of auxiliary decoder network 6 can in addition be optimized according to block 241. The final optimized state of these parameters 6a is designated by the reference sign 6a*. According to block 241a, during the training of auxiliary decoder network 6, the parameters 5a that characterize the behavior of transformer network 5 can be held constant.

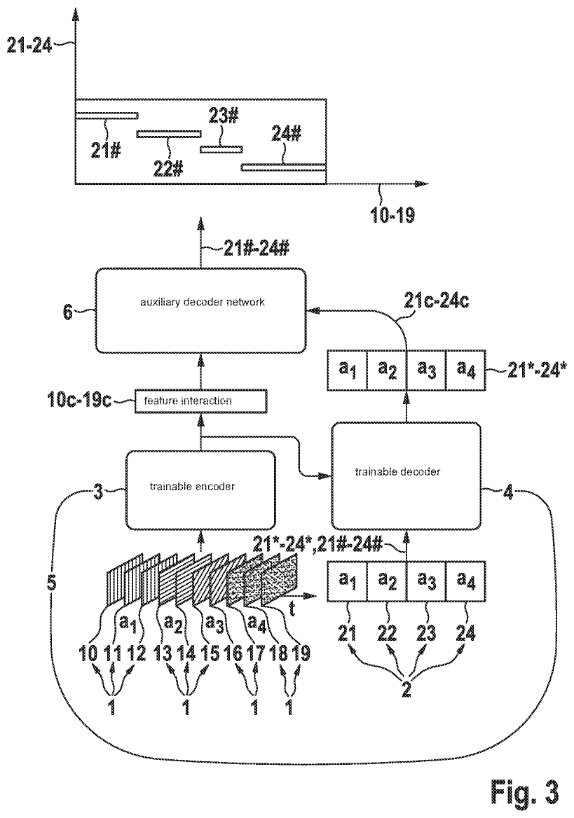

FIG. 3 schematically shows an exemplary system of a transformer network 5 and an auxiliary decoder network 6. Transformer network 5 includes an encoder 3 and a decoder 4. The encoder ascertains from the video frames 10-19 of frame sequence 1, which during training with target classes a₁ to a₄ are labeled as ground truth, feature interactions 10c-19c; for clarity, the extraction of features 10a-19a and feature representations 10b-19b are not shown. These feature interactions 10c-19c are processed by decoder 4 together with classes 21*-24*, and optionally also with the occupied sections 21#-24# on the time axis, for the already recognized scenes 21-24 to form classes 21*-24* for one or more further scenes 21-24. The scene-feature interactions 21c-24c are supplied, together with the feature interactions 10c-19c, to auxiliary decoder network 6, and are processed there to form the occupied sections 21#-24# on the time axis for the further scenes 21-24. This ultimately results in a division of the time axis into sections 21#-24# that correspond to scenes 21-24 with classes 21*-24*.

What is claimed is:

1. A method for transforming a frame sequence of video frames into a scene sequence of scenes that belong to different classes of a predetermined classification and that each extend over a region on a time axis, the method comprising the following steps:
extracting features from each video frame of the frame sequence;
transforming the features belonging to each video frame into a feature representation in a first working space;
ascertaining, with a trainable encoder of a transformer network, a feature interaction of each feature representation with respectively other feature representations, the feature interactions characterizing a frame prediction;
transforming a class belonging to each already-ascertained scene into a scene representation in a second working space, into which a position of the respective scene in the scene sequence is encoded;
ascertaining, with a trainable decoder of the transformer network, a scene interaction of each scene representation with each of all other scene representations;
ascertaining, with the decoder, a scene-feature interaction of each scene interaction with each feature interaction; and
ascertaining from the scene-feature interactions, with the decoder at least the class of a next scene in the scene sequence that is most plausible in view of the frame sequence and the already-ascertained scenes.

2. The method as recited in claim 1, wherein the ascertaining of the feature interactions include:
ascertaining similarity measures between each respective feature representation and each of all the other feature representations, and
aggregating contributions of each of the other feature representations in weighted fashion with the similarity measures.

3. The method as recited in claim 1, wherein the ascertaining of the scene interactions include:
ascertaining similarity measures between each respective scene representation and each of all the other scene representations, and
aggregating contributions from each of the other scene representations in weighted fashion with the similarity measures.

4. The method as recited in claim 1, wherein the ascertaining of the scene-feature interactions include:
ascertaining similarity measures between each respective scene interaction and the feature interactions, and
aggregating contributions of the feature interactions in weighted fashion with these similarity measures.

5. The method as recited in claim 1, wherein:
the feature representations, the feature interactions, the scene representations, the scene interactions , and the scene-feature interactions are each divided into a query portion, a key portion, and a value portion;
query portions being capable of being compared to key portions for the calculation of similarity measures, and
value portions being capable of being aggregated in weighted fashion with similarity measures.

6. The method as recited in claim 1, wherein both the class of the next scene and the region on the time axis over which the next scene extends are ascertained with the decoder of the transformer network.

7. The method as recited in claim 1, wherein the region on the time axis over which the next scene extends is ascertained using a trained auxiliary decoder network that receives as inputs both the classes provided by the decoder of the transformer network and the feature interactions.

8. A method for training a transformer network, comprising the following steps:
providing training frame sequences of video frames that are labeled with target classes of scenes to which the video frames respectively belong;
transforming each training frame sequence into a scene sequence of scenes by:
extracting features from each video frame of the frame sequence,
transforming the features belonging to each video frame into a feature representation in a first working space,
ascertaining, with a trainable encoder of a transformer network, a feature interaction of each feature representation with respectively other feature representations, the feature interactions characterizing a frame prediction,
transforming a class belonging to each already-ascertained scene into a scene representation in a second working space, into which a position of the respective scene in the scene sequence is encoded,
ascertaining, with a trainable decoder of the transformer network, a scene interaction of each scene representation with each of all other scene representations,
ascertaining, with the decoder, a scene-feature interaction of each scene interaction with each feature interaction, and
ascertaining from the scene-feature interactions, with the decoder at least the class of a next scene in the scene sequence that is most plausible in view of the frame sequence and the already-ascertained scenes;
evaluating, with a predetermined cost function, to what extent at least the ascertained scene sequence is in accord with the target classes of scenes with which the video frames in the training frame sequences are labeled; and
optimizing parameters that characterize the behavior of the transformer network with a goal that upon further processing of training frame sequences, the evaluation by the cost function is expected to improve.

9. The method as recited in claim 8, wherein the video frames in the training frame sequences, as well as the ascertained scenes, are sorted according to class, and the cost function measures an agreement of the class prediction, respectively averaged over all members of the classes, with the respective target class.

10. The method as recited in claim 8, wherein the cost function measures an extent to which the decoder assigns each video frame to a correct scene.

11. The method as recited in claim 8, wherein parameters that characterize a behavior of the auxiliary decoder network are optimized, and the cost function measures an extent to which the auxiliary decoder network assigns each video frame to a correct scene.

12. The method as recited in claim 11, wherein parameters that characterize a behavior of the transformer network is held constant during the training of the auxiliary decoder network.

13. The method as recited in claim 8, wherein the labeled video frames are clustered with respect to their target classes, and missing target classes for unlabeled video frames are ascertained corresponding to the clusters to which the unlabeled video frames belong.

14. A non-transitory machine-readable data carrier on which is stored a computer program for transforming a frame sequence of video frames into a scene sequence of scenes that belong to different classes of a predetermined classification and that each extend over a region on a time axis, the computer program, when executed by one or more computers and/or compute instances, cause the one or more computers and/or compute instances to perform the following steps:
extracting features from each video frame of the frame sequence;
transforming the features belonging to each video frame into a feature representation in a first working space;
ascertaining, with a trainable encoder of a transformer network, a feature interaction of each feature representation with respectively other feature representations, the feature interactions characterizing a frame prediction;
transforming a class belonging to each already- ascertained scene into a scene representation in a second working space, into which a position of the respective scene in the scene sequence is encoded;
ascertaining, with a trainable decoder of the transformer network, a scene interaction of each scene representation with each of all other scene representations;
ascertaining, with the decoder, a scene-feature interaction of each scene interaction with each feature interaction; and
ascertaining from the scene-feature interactions, with the decoder at least the class of a next scene in the scene sequence that is most plausible in view of the frame sequence and the already-ascertained scenes.

15. One or more computers and/or compute instances configured to transform a frame sequence of video frames into a scene sequence of scenes that belong to different classes of a predetermined classification and that each extend over a region on a time axis, the one or more computers and/or compute instances configured to:
extract features from each video frame of the frame sequence;
transform the features belonging to each video frame into a feature representation in a first working space;
ascertain, with a trainable encoder of a transformer network, a feature interaction of each feature representation with respectively other feature representations, the feature interactions characterizing a frame prediction;
transform a class belonging to each already- ascertained scene into a scene representation in a second working space, into which a position of the respective scene in the scene sequence is encoded;
ascertain, with a trainable decoder of the transformer network, a scene interaction of each scene representation with each of all other scene representations;
ascertain, with the decoder, a scene-feature interaction of each scene interaction with each feature interaction; and
ascertain from the scene-feature interactions, with the decoder at least the class of a next scene in the scene sequence that is most plausible in view of the frame sequence and the already-ascertained scenes.
